(19) United States
(12) Patent Application Publication
(10) Pub. No.: US 2003/0229724 A1
(43) Pub. Date: Dec. 11, 2003

(54) Systems and methods for synchronzing processes

(76) Inventors: Roland L. Arajs, San Jose, CA (US); Layne Miller, Campbell, CA (US); Rob Petri, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/170,271

(22) Filed: Jun. 10, 2002

(51) Int. Cl. G06F 9/46

(52) U.S. Cl. 709/313; 709/312

(57) ABSTRACT

A communications system for a multiple processor computer system allows source computing elements to send messages to target computing elements without needing to know where the target computing elements are located in the system. Computing elements running on a processor within the multiple processor system access the communications system using the same code routines regardless of the location of the message targets. Remote computing elements are synchronized with local computing elements. Messages are seamlessly copied across processors when the target computing element is remote from the source computing element.

### FIELD OF THE INVENTION

This invention is related to network processor computing systems, and more particularly to systems and methods for managing communications within a network processor system.

### BACKGROUND

Within a computer system, there are various processes, tasks and other such computing elements that execute on the processor or processors within the computer system. From time to time, these computing elements need to communicate with each other, for example to share data, or to pass instructions from one computing element to another, or any of a variety of other reasons.

A communications system 100 for communicating between two computing elements, when both computing elements are executing on the same processor, is shown in FIG. 1A. The communications system 100 includes a source computing element 110(a), which generates a message intended for a target computing element 110(b). This message can be any sort of message useful to the proper functioning of the various processes within the computer system. The communications system 100 also includes two message modules 123, a source message module 123(a) and an target message module 123(b). The source message module 123(a) is responsible for gathering the message from the source computing element 110(a). The target message module 123(b) is responsible for routing the message to the target computing element 110(b). The message is stored in a shared memory area 127, so that no physical copying is required when transmitting the message. The shared memory area 127 is linked to the source computing element 120 by the source message module 123(a), and linked to the target computing element 110(b) by the target message module 123(b).

The communications system 100 of FIG. 1A is used to send a message according to the method of FIG. 1B. When a source computing element 110(a) wishes to send a message to a target computing element 110(b), the source computing element 110(a) first identifies the particular target computing element 110(b) to which the message will be sent, at step 180. The source computing element 110(a) then sends the message to the source message module 123(a), at step 182. The message is then sent by the source message module 123(a) to the shared memory area 127, at step 184. The message is then read from the shared memory area 127 by the target message module 123(b) at step 186, and forwarded to the target computing element 110(b), at step 188.

The communications system 100 described above works for communications between processes running on the same processor, with access to the same shared memory area 127. However, in a multiple processor system, there is no memory area shared by processes running on different processors, since the processors are physically located on separate boards. Therefore, the system of FIG. 1A is not effective for managing messages fromprocesses on different processors.

### BRIEF DESCRIPTION OF THE DRAWINGS

The components in the figures are not necessarily to scale, emphasis instead being placed upon illustrating the principles of various embodiments of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1A is a single-processor communications system.

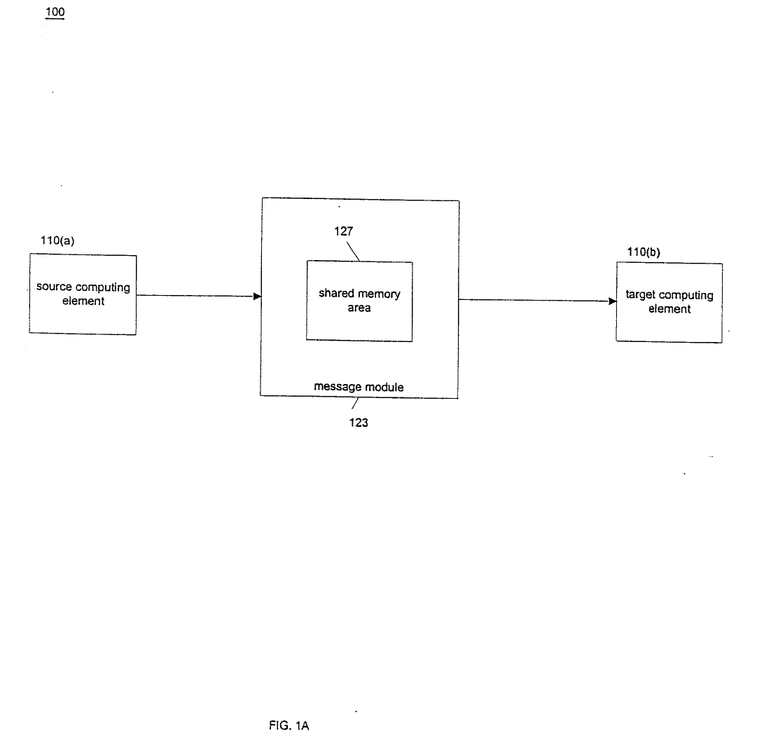

FIG. 1B is a flowchart of a method for sending messages in a single-processor communications system.

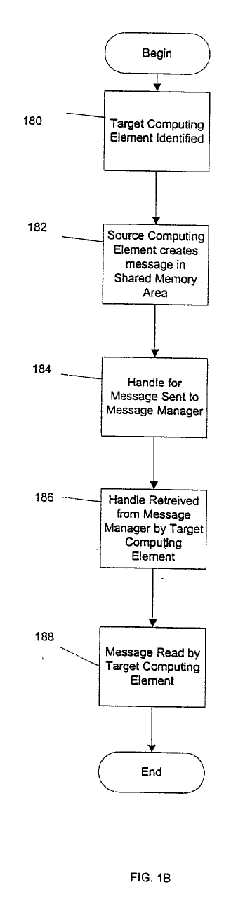

FIG. 2A is a general layout of a multiple processor communications system.

FIG. 2B is a flowchart of a general method of sending messages in a multiple processor communications system.

FIG. 3A is a block diagram of a communications module.

FIG. 3B is a block diagram of a multiple processor communications system.

FIG. 4 is a flowchart of a method for sending a message from a source processor to a target processor.

FIG. 5 is a flowchart of a method for posting information about a newly activated computing element to a network.

FIG. 6 is a flowchart of a method for updating a communications module with information about a newly activated computing element.

FIG. 7 is a flowchart of a method for posting information about a newly deactivated computing element to a network.

FIG. 8 is a flowchart of a method for updating a communications module with information about a newly-deactivated computing element.

### DETAILED DESCRIPTION

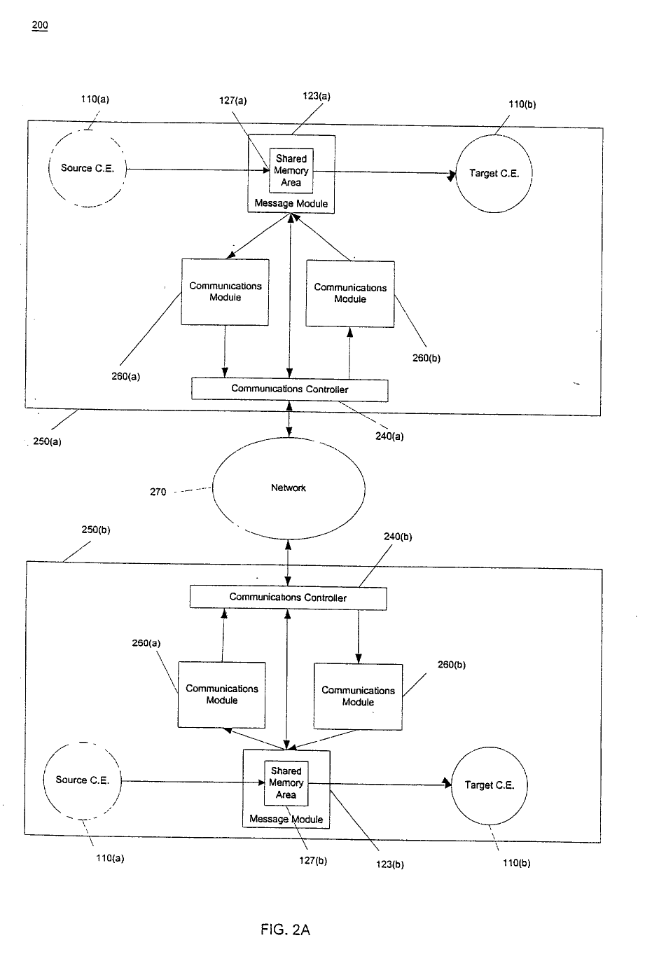

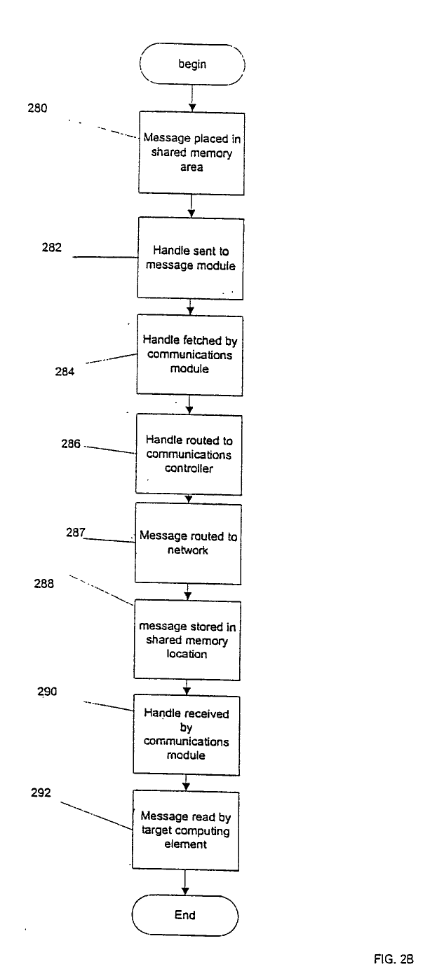

A general layout of a communications system 200 of an embodiment of the invention is shown in FIG. 2A. The communications system 200 includes a first processor 250(a) and a second processor 250(b), which are processors 250 responsible for sending and receiving messages within a multiple processor computer system. The communications system 200 also includes an intermediate message receiver, such as a network 270, that links the first processor 250(a) and the second processor 250(b). The network 270 can be any form of connection used to link processors within a multiple processor computer system, such as a wire, bus, telephone line, fiber optic link, radio or other electromagnetic wave, local area network (LAN), wide area network (WAN), etc.

Each processor 250 includes computing elements 110 that send and receive messages, message modules 123 that route messages to and from computing elements 110, shared memory areas 127 that store messages, communications modules 260 that process messages destined for remote processors 250, and communications controllers 240 that route messages between processors 250. Each computing element 110 may be a process, task or other similar element running on a processor 250, or may be a module that manages one or more process, tasks or similar elements. For example, a name server or a resolver is a computing element within a multiple processor environment.

For purposes of illustration, a computing element 110 that is sending a message is referred to as a “source computing element” and a computing element 110 that is receiving a message is referred to as a “target computing element.” Any given computing element 110 is capable of performing both tasks, as called for by the parameters of the multiple processor computer system. The source computing element 110(a) uses the same code routines to send a message to the target computing element 110(b) regardless of the location of the target computing element 110(b). The target computing element 110(b) uses the same code routines to receive a message regardless of the location of the source computing element 110(a). In an alternate embodiment where the source computing element 110(a) and the target computing element 110(b) are both located on the same processor 250, the shared memory area 127 on the processor 250 containing the source computing element 110(a) and target computing element 110(b) serves as the intermediate message receiver discussed above.

A source message module 123(a) is adapted to receive messages from a source computing element 110(a) and forward them to a shared memory area 127 located in the processor 250, which is the location where messages from a source computing element 110(a) to a target computing element 110(b) are stored. A target message module 123(b) is adapted to receive messages from a shared memory area 127 and forward the messages to a target computing element 110(b).

The communications controllers 240 are responsible for routing messages across the network 270 between the processors 250. The communications modules 260 manage access to the computing elements 110, route messages to and from the communications controllers 240, and maintain information about the various computing elements 110 that are connected to the network 270, so that messages can be properly routed between processors 250.

A general method of operation of the communication system 200 to send a message from a source computing element 110(a) to a target computing element 110(b) on a different processor 250 is shown in FIG. 2B, with reference to FIG. 2A. For purposes of illustration, it is assumed that the message originates in the source computing element 110(a) on the first processor 250(a). The source computing element 110(a) sends the message to the source message module 123(a) in the first processor 250(a), at step 280. The message is placed in the first shared memory area 127(a), at step 282. The source communications module 260(a) recognizes that the target computing element 110(b) is located on the second processor 250(b), and fetches the message stored in the first shared memory area 127(a), at step 284. The source communications module 260(a) determines the location of the target computing element 110(b) and routes the message to the network 270, via the first communications controller 240, for delivery to the target processor 250(b), at step 286. The second communications controller 240(b) on the second processor 250(b) receives the message from the network 270 and routes it to the target communications module 260(b) at step 288. The target communications module 260(b) routes the message to the second shared memory area 127(b), at step 290. The target message module 123(b) then forwards the message from the second shared memory area 127(b) to the target computing element 110(b), at step 292.

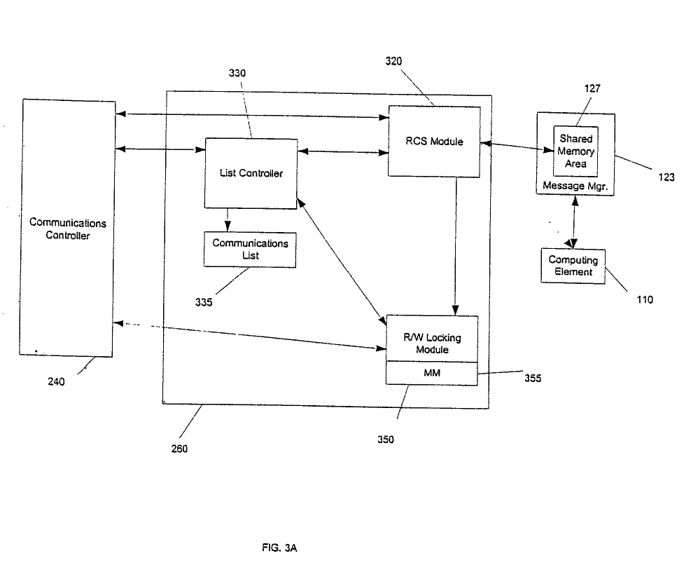

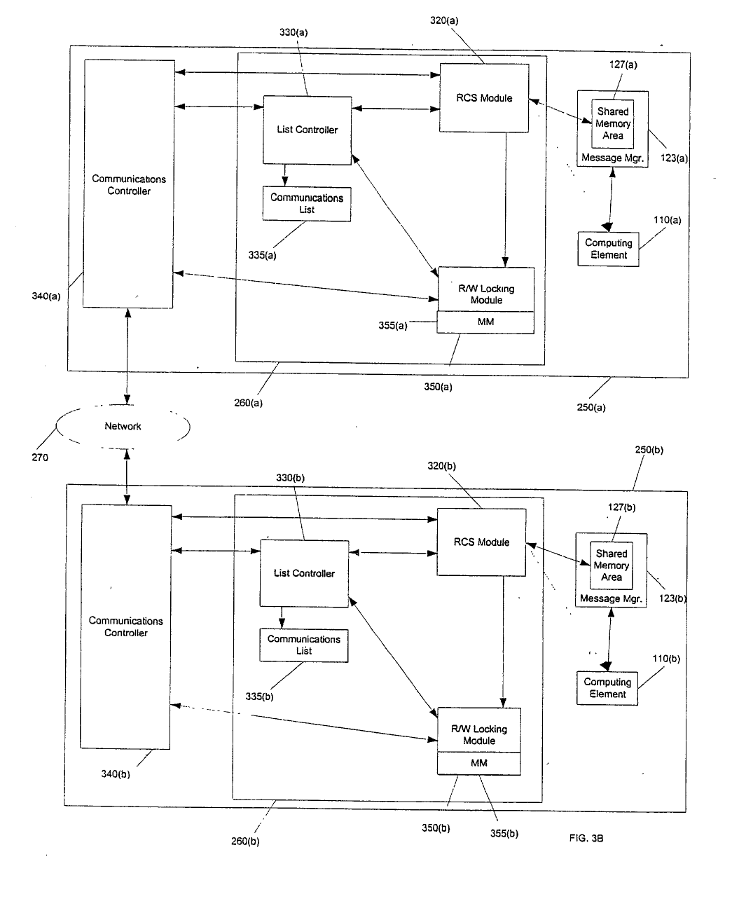

The structure of a communications module 260, such as the first communications module 260(a) and the second communications module 260(b), is discussed in more detail with reference to FIG. 3A. The communications module 260 receives messages from a computing element 110, and relays these messages to a communications controller 240, and also receives messages from the communications controller 240 and relays these messages to the computing element 110. The communications module 260 includes several components: 1) a remote component synchronization (RCS) module 320, which is responsible for synchronizing information between local and remote computing elements 110; 2) a list controller 330, which maintains information about the computing elements 110 that the communications module 260 is able to communicate with; 3) a communications list 335, which contains a list of all computing elements 110 on the first processor 250(a), the second processor 250(b), and any other remote processors 250 in the multiple processor system; and 4) a read/write (R/W) locking module 350, which is responsible for regulating access to the computing elements 110 linked to the communications module 260. In a processor of an embodiment, there is a communications module 260 associated with each computing element 110 resident in the processor. Thus, each computing element 110 is linked to a separate RCS module 320, list controller 330, and R/W locking module 350. The communications controller 240 is shared by all computing elements 110 resident on the processor. In alternate embodiments, one or more of the elements of the communications module 260 are shared among multiple computing elements 110 on the processor.

The RCS module 320 performs several functions. The RCS module 320 is responsible for creating the list controller 330 and the R/W lock module 350. The RCS module 320 is also responsible for synchronizing information between the communications module 260 and any other remote communications modules 260 resident in the multiple processor computer system. For example, if a new computing element 110 is created and linked to the communications module 260, the RCS module 320 allocates a shared memory area 127 to store messages sent to the new computing element 110, and then propagates information about the new computing element 110 to the remote communications modules 260, so that other computing elements 110 running on the remote processors will be able to locate the new computing element 110. When a new computing element 110 is created, the RCS module 320 also notifies the R/W lock module 350 and the communications controller 240 of the shared memory area 127 that will be used to store incoming messages for the new computing element 110. The RCS module 320 also maintains a list of remote computing elements 110 that are available on the multiple processor system.

The list controller 330 is responsible for updating the RCS module 320 and the R/W lock module 350 when remote computing elements 110 are added or removed from the remote processors 250 within the multiple processor system. The list controller 330 also is responsible for notifying the communications controller 240 when a computing element 110 is added to or removed from the local processor 250 that the communications module 260 is running on.

The list controller 330 creates the communications list 335. This list can include information such as an identifier for each computing element 110, a processor identifier that indicates which processor 250 each computing element 110 is resident on, a pointer to a source or target memory area for storing information for each computing element 110, a service identifier that identifies a type of each computing element 110 (for example, a service identifier may identify the computing element 110 as a name server, or as a resolver), or any other information useful to the communications process. The communications list 335 contains an entry for each connection between computing elements 110 on the various processors 250 of the multiple processor system.

Each list entry contains information common to all computing elements 10 using the connection, such as a connection name, a communication type, or an identifier of the type of the computing elements 110 belonging to the connection, as well as a pointer to context-specific information for each computing element 110 joining in the connection. The context-specific information is managed by each computing element 110.

The R/W locking module 350 is responsible for regulating access to the computing elements 110 linked to the communications module 260. There is a R/W locking module 350 associated with each computing element 110. The R/W locking module 350 is used to implement a locking scheme, in order to ensure that messages being sent across the network 270 to and from the communications module 260 do not collide and case data corruption. An example locking scheme uses the following rules:

Only one RCS module 320 at a time may hold a write lock on any given computing element 110, though the RCS module 320 may hold write locks on several computing elements 110 at the same time. This insures that only one RCS module 320 at a time can write data to a computing element 110, thus avoiding a write collision.

The write lock for a computing element 110 will only be granted to the RCS module 320 when all outstanding read locks on the computing element 110 have been released, and all outstanding read lock requests have been granted and released. This insures that data being read from the computing element 110 will not be corrupted by an incoming write operation.

The RCS module 320 holding the write lock on a computing element 110 may acquire one or more read locks on the computing element 110, but any other RCS modules 320 may not get a read lock on the computing element 110 until the write lock has been released. This assumes that the RCS module 320 holding the write lock can manage its own I/O to avoid a read/write collision.

An RCS module 320 may acquire one or more read locks on a computing element 110, so long as no other RCS modules 320 hold the write lock for the computing element 110.

The RCS module 320 creates the R/W locking module 350 when the computing element 110 is activated. The R/W locking module 350 also includes a message module 355. This message module 355 maintains a list of remote computing elements 110 that are available on the multiple processor system. The message module 355 is used to send lock updates to the other R/W locking modules 350 on the other communications modules 260 in the multiple processor system. Whenever the list controller 330 is notified of a new computing element 10 being activated or an existing computing element 110 being deactivated, the list controller 330 notifies the R/W locking module 350 of the activated or deactivated computing element 110, and the list of remote computing elements 110 is updated accordingly.

The communications controller 240 will now be discussed in more detail. The communications controller 240 receives outgoing messages from the RCS module 320 or the R/W locking module 350 and sends them to the network 270. The communications controller 240 also receives incoming messages from the network 270 and routes them to the RCS module 320, the R/W locking module 350, and the list controller 330.

Additionally, the communications controller 240 helps the communications module 260 synchronize information between the various processors 250 within the multiple processor system. The communications controller 240 notifies the list controller 330 about the availability of remote computing elements 110. When the list controller 330 notifies the communications controller 240 that a new computing element 110 has been added to the local processor 250, the communications controller 240 allocates a shared memory area 127 to store the outgoing messages from the new computing element 110, and notifies the list controller 330 of the address of the allocated shared memory area 127. When the communications controller 240 is notified that a remote computing element 110 has become unavailable, the communications controller 240 informs the list controller 330 of this development. When the list controller 330 notifies the communications controller 240 that a local computing element 110 has become unavailable, the communications controller 240 posts that information to the network 270, where the information is made available to the remote communications controllers 240 on the remote processors.

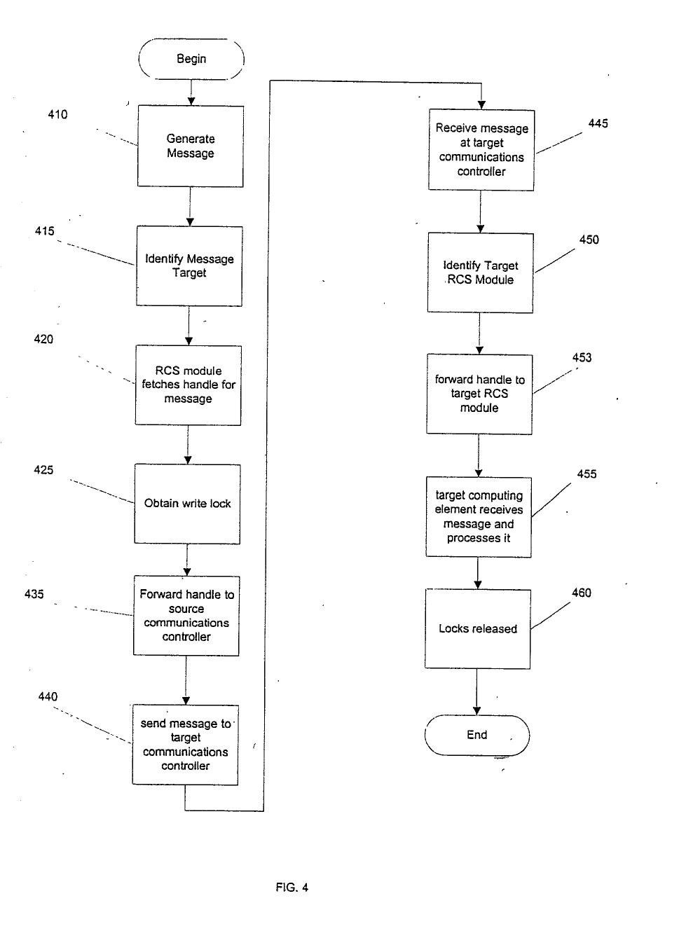

The communications modules 260(a) and 260(b) are used to send a message from a source computing element 110(a) on the first processor 250(a) to a target computing element 110(b) on the second processor 250(b) as shown in the flowchart of FIG. 4, with reference to FIG. 3B. A message is generated in the source computing element 110(a), at step 410. This message is to be sent to the target computing element 110(b) on the second processor 250(b), remote to the first processor 250(a). The source computing element 110(a) identifies the target computing element 110(b) at step 415. The source computing element 110(a) knows the identity of the target computing element 110(b), but does now know which processor 250 contains the target computing element 110(b). At step 420, the source computing element 110(a) passes the message to the source message module 123(a), where the message is deposited in the first shared memory area 127(a). The source RCS module 320(a) receives the message and attempts to get a write lock on the computing elements 110(a) and 110(b), at step 425. The source R/W locking module 350(a) locks the source computing element 110(a) and sends lock requests to the target computing element 110(b). The target R/W locking module 350(b) responds by locking the target computing element 110(b).

Once the locks have been negotiated, at step 435 the source RCS module 320(a) forwards the message to the source communications controller 240(a). The source communications controller 240(a) selects the target communications module 260(b) on the target processor 250(b) as the target of the message, based upon the information received from the target compuing module 110(b) when it was activated, as discussed below.

At step 440, the source communications controller 240(a) sends the message to the target communications controller 240(b), over the network 270. At step 445, the target communications controller 240(b) receives the message. At step 450, the target communications controller 240(b) selects the target RCS module 320(b), associated with the target computing element 110(b), from the RCS modules 320 resident on the target processor 250(b). At step 453, the target RCS module 320(b) deposits the message in the shared memory area 127(b), allocated to receive messages for the target computing element 110(b), and obtains a read lock on the target computing element 110(b). At step 455, the target computing element 110(b) receives the message from the target message manager 123(b) and processes it. Once the target computing element 110(b) has finished receiving the message, then at step 460, the source RCS module 320(a) releases the write lock on the source computing element 110(a) and the target computing element 110(b), and the target RCS module 320(b) releases the read lock on the target computing element 110(b).

From time to time in the operation of the multiple processor system, new computing elements 110 are activated on the various processors 250 in the system. Before a message is sent to a newly activated computing element 110, the newly activated computing element 110 is synchronized with the other computing elements 110 of the same type, so that the other computing elements 110 are aware of the existence of the newly activated computing element 110.

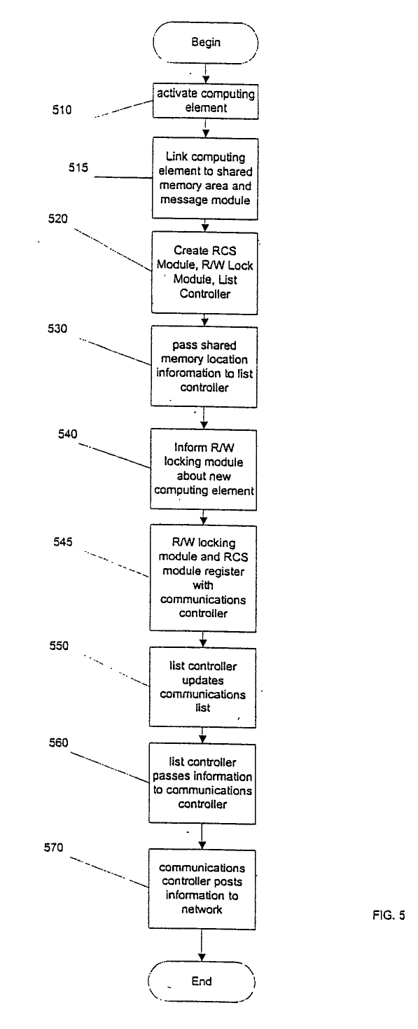

A method of posting a newly activated computing element 110 to the network 270 is shown in FIG. 5, with reference to FIG. 3A. At step 510, a computing element 110 is activated on a processor 250. At step 515 the computing element 110 is linked to a shared memory area 127 and message manager 123. At step 520, the computing element 110 notifies its associated RCS module 320 that it has been activated. The RCS module 320 passes a pointer to the shared memory area 127(b) to the list controller 330, at step 530. At step 540, the RCS module 320 passes a pointer to the shared memory area 127 to the R/W locking module 350 as well. At step 545, the R/W locking module 350 adds the computing element 110 to the list maintained in the message module 355. At step 550, the list controller 330 updates the communications list 355 with the relevant information about the computing element 110, including the name of the computing element 110, the address of the shared memory area 127, the service identifier for the computing element 110, the processor identifier for the computing element 110, and any other relevant information. At step 560, the list controller 330 passes the information about the computing element 110 to the communications controller 240. At step 570, the communications controller 240 posts the computing element 110 information to the network 270, where it is available to be received by the other communications controllers 240 on the other processors 250 in the multiple processor system.

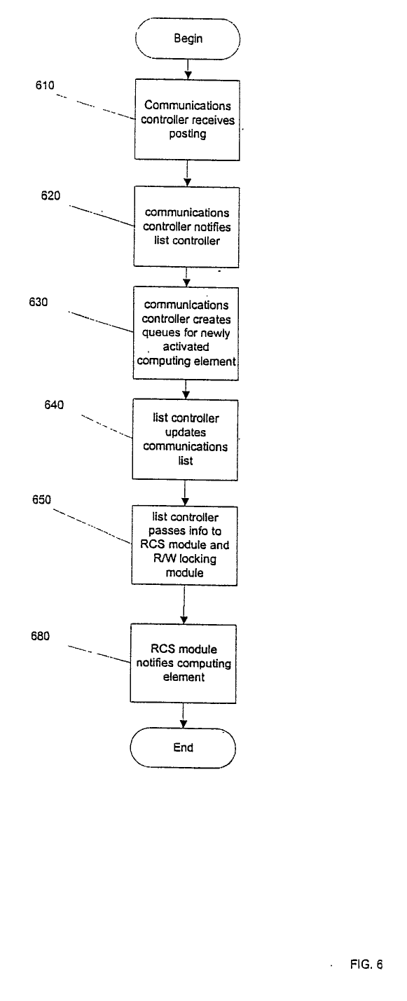

A method for updating an existing computing element 110 with information about a newly activated computing element 110 is shown in FIG. 6, with reference to FIG. 3A. At step 610, the communications controller 240 receives a posting of a newly activated computing element 110 from the network 270. This posting may be sent using the method of FIG. 5, or any other method for posting information to the network 270. At step 620, the communications controller 240 informs the list controller 330 about the newly activated computing element 110. At step 630, the communications controller 240 links the shared memory area 127 associated with the existing computing element 110 to the newly activated computing element 110. At step 640, the list controller 330 updates the communications list 335 with the information about the newly activated computing element 110. At step 650, the list controller 330 passes the newly activated computing element 110 information to the RCS module 320 and the R/W locking module 350. At step 660, the RCS module 320 updates its list of computing elements with the newly activated computing element 110 information, so that future messages sent to the newly activated computing element 110 are properly routed. At step 670, the R/W locking module 350 updates the message module 355 with the newly activated computing element 110 information, so that locking messages are properly sent to the newly activated computing element 110. Finally, at step 680, the RCS module 320 notifies the existing computing element 110 of the newly activated computing element 110, so that the existing computing element 110 is able to send messages to the newly activated computing element 110.

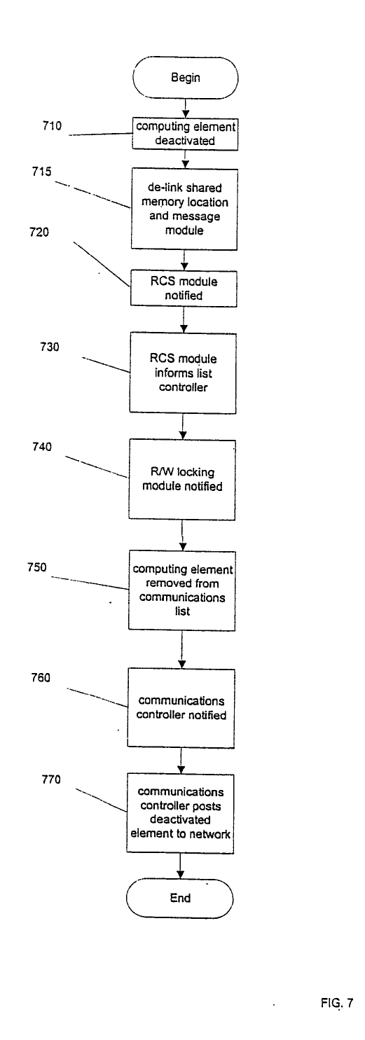

From time to time in the operation of the multiple processor system, a computing element 110 finishes execution or otherwise ceases activity. The other processors 250 in the multiple processor system are synchronized with information about the unavailability of the computing element 110, according to the method of FIG. 7, with reference to FIG. 3A. At step 710, the computing element 110 is deactivated. At step 715, the shared memory area 127 is unlinked from the deactivated computing element 110. At step 720, the computing element 110 notifies the RCS module 320 about this deactivation. At step 730, the RCS module 320 informs the list controller 330 of the deactivation of the computing element 110. At step 740, the RCS module 320 informs the R/W locking module 350 of the deactivation of the computing element 110. At step 745, the R/W locking module 350 removes the computing element 110 from the message module 355. At step 750, the list controller 330 removes the computing element 110 from the communications list 335. At step 760, the list controller 330 informs the communications controller 240 about the deactivation of the computing element 110. At step 770, the communications controller 240 posts the deactivation of the computing element 110 to the network 270, where this information is made available to the other processors 250 running on the multiple processor system.

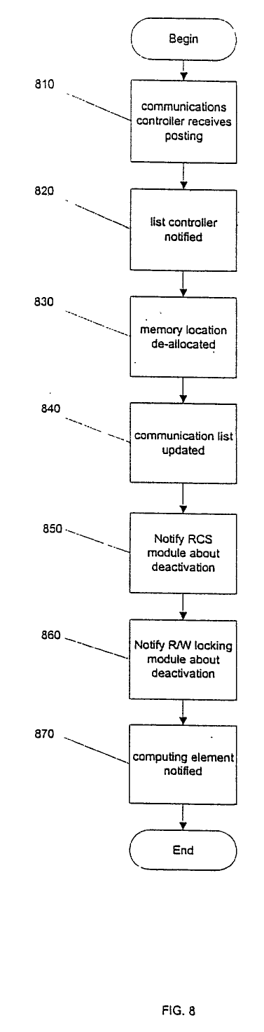

An active computing element 110 is updated with information about a deactivated computing element 110 according to the method of FIG. 8, with reference to FIG. 3A. At step 810, the communications controller 240 receives a posting of a deactivated computing element 110 from the network 270. This posting may be sent using the method of FIG. 7, or by any other method of posting information to the network 270. At step 820, the communications controller 240 informs the list controller 330 about the deactivated computing element 110. At step 830, the communications controller 240 unlinks the shared memory area 127 from the deactivated computing element 110. At step 840, the list controller 330 updates the communications list 335 by removing the deactivated computing element 110 entry from the list. At step 850, the list controller 330 passes the deactivated computing element 110 information to the RCS controller 320 and the R/W locking module 350. At step 860, the RCS module 320 removes the deactivated computing element 110 entry, so that no messages will be sent to the deactivated computing element 110. At step 870, the R/W locking module 350 updates the message module 355 by removing the deactivated computing element 110 entry from the message module 355, so that no locking messages will be sent to the deactivated computing element 110. Finally, at step 880, the source RCS module 320 notifies the active computing element 110 of the deactivated computing element 110, so that no messages will be generated for the deactivated computing element 110.

In the foregoing specification, embodiments of the invention have been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and embodiments of the invention can be performed using different or additional process actions, or a different combination or ordering of process actions. The specification and drawings are, accordingly, to be regarded in an illustrative rather than restrictive sense, and embodiments of the invention are not to be restricted or limited except in accordance with the following claims and their legal equivalents.

We claim:

1. A system, comprising:
a communications module that receives from a source computing element a message bound for a target computing element, and determines whether the target computing element shares a memory space with the source computing element; and
a communications controller coupled to the communications module that receives the message from the communications module and forwards the message to an intermediate message receiver.

2. The system of claim 1, wherein the intermediate message receiver comprises a network.

3. The system of claim 1, wherein the intermediate message receiver comprises a shared memory area.

4. The system of claim 1, wherein the communications module comprises a list controller that maintains a list of computing elements accessible to the communications module and a remote component synchronization (RCS) module that synchronizes information between the source computing element and the target computing element.

5. A system for communicating between multiple processors, comprising:
a source processor,
a target processor,
a source computing element that runs on the source processor to generate a message,
a target computing element that runs on the target processor to receive the message,
a network that transmits the message from the source processor to the target processor,
a source communications module that sends the message from the source computing element to the network, and
a target communications module that receives the message from the network and forwards the message to the target computing element.

6. The system of claim 5, further comprising a source communications controller that receives the message from the source communications module and sends the message to the network.

7. The system of claim 5, further comprising a source message module including a source memory area that receives the message from the source computing element.

8. The system of claim 5, further comprising a target communications controller that receives the message from the network and sends the message to the target communications module.

9. The system of claim 5, further comprising a target message module including a target memory area that provides the message to the target computing element.

10. A communications module for a processor, comprising:
a list controller that maintains a list of computing elements accessible to the communications module, and
a remote component synchronization (RCS) module that synchronizes information between a local computing element and a remote computing element.

11. The communications module of claim 10, further comprising a read/write (RIW) locking module that regulate access to the local computing element.

12. The communications module of claim 10, further comprising a communications controller that send messages to and receive messages from a network.

13. The communications module of claim 11, wherein the R/W locking module comprises a message manager that manages locking messages relating to the local computing element.

14. The communications module of claim 10, wherein the list of computing elements comprises a list of local computing elements.

15. The communications module of claim 10, wherein the list of computing elements comprises a list of remote computing elements.

16. The communications module of claim 10, further comprising a message manager that receives a message from the local computing element.

17. A method of sending a message to a network from a source computing element, comprising:
generating the message in the source computing element;
forwarding the message to a message manager;
storing the message in a memory area;
looking up an eventual target for the message; and
forwarding the message to the network.

18. The method of claim 17, further comprising obtaining a write lock on a target computing element, the target computing element being the eventual target of the message.

19. The method of claim 17, further comprising obtaining a write lock on the source computing element.

20. A method of receiving a message to a target computing element from a network, comprising:
receiving the message from the network;
storing the message in a memory area;
forwarding the message to a message manager, and
providing the message to the target computing element.

21. The method of claim 20, further comprising obtaining a write lock on the target computing element.

22. The method of claim 20, further comprising obtaining a read lock on the target computing element.

23. A method of making a computing element accessible to a network, comprising:
activating the computing element;
providing a memory area to store incoming messages for the computing element;
listing the computing element; and
posting the information about the computing element to the network.

24. The method of claim 23, wherein the information about the computing element comprises a service identifier.

25. The method of claim 23, wherein the information about the computing element comprises a memory area identifier.

26. The method of claim 23, wherein the information about the computing element comprises a processor identifier.

27. The method of claim 23, further comprising preparing read/write locking information for the computing element.

28. A method for recognizing a remote computing element, comprising:
receiving information identifying the remote computing element from a network;
listing the remote computing element; and
providing a memory area to store outgoing messages to the remote computing element.

29. The method of claim 28, further comprising preparing read/write locking information for the remote computing element.

30. The method of claim 28, wherein the information identifying the remote computing element comprises a service identifier.

31. The method of claim 28, wherein the information identifying the remote computing element comprises a memory area identifier.

32. A method of making a computing element inaccessible to a network, comprising:
deactivating the computing element;
de-allocating a memory area, the memory area to store incoming messages to the computing element;
delisting the computing element; and
posting the information about the deactivated computing element to the network.

33. The method of claim 32, wherein the information about the computing element comprises a service identifier.

34. The method of claim 32, wherein the information about the computing element comprises a target memory area identifier.

35. The method of claim 32, further comprising deactivating read/write locking information for the computing element.

36. A method for deactivating access to a remote computing element on a network, comprising:
receiving information identifying the remote computing element;
de-listing the remote computing element; and
de-allocating a memory area, the memory area to store outgoing messages to the remote computing element.

37. The method of claim 36, further comprising deactivating read/write locking information for the computing element.

38. The method of claim 36, wherein the information identifying the remote computing element comprises a service identifier.

39. The method of claim 36, wherein the information identifying the remote computing element comprises a source memory area identifier.

40. A computer-usable medium comprising a sequence of instructions which, when executed by a processor, causes the processor to:
Generate a message in a source computing element;
forward the message to a message manager;
store the message in a memory area;
look up an eventual target for the message; and
forward the message to a network.

41. The computer-usable medium of claim 40, further comprising a sequence of instructions which, when executed by a processor, causes the processor to obtain a write lock on a target computing element, the target computing element being the eventual target of the message.

42. The computer-usable medium of claim 40, further comprising a sequence of instructions which, when executed by a processor, causes the processor to obtain a write lock on the source computing element.

43. A computer-usable medium comprising a sequence of instructions which, when executed by a processor, causes the processor to:
receive a message from a network;
store the message in a memory area;
forward the message to a message manager; and
provide the message to a target computing element.

44. The computer-usable medium of claim 43, further comprising a sequence of instructions which, when executed by a processor, causes the processor to obtain a write lock on the target computing element.

45. The computer-usable medium of claim 43, further comprising a sequence of instructions which, when executed by a processor, causes the processor to obtain a read lock on the target computing element.

46. A computer-usable medium comprising a sequence of instructions which, when executed by a processor, causes the processor to:
activate a computing element;
provide a memory area to store incoming messages for the computing element;
list the computing element; and
post information about the computing element to the network.

47. The computer-usable medium of claim 46, wherein the information about the computing element comprises a service identifier.

48. The computer-usable medium of claim 46, wherein the information about the computing element comprises a memory area identifier.

49. The computer-usable medium of claim 46, wherein the information about the computing element comprises a processor identifier.

50. The computer-usable medium of claim 46, further comprising a sequence of instructions which, when executed by a processor, causes the processor to prepare read/write locking information for the computing element.

51. A computer-usable medium comprising a sequence of instructions which, when executed by a processor, causes the processor to:
receive information identifying a remote computing element from a network;
list the remote computing element; and
provide a memory area to store outgoing messages to the remote computing element.

52. The computer-usable medium of claim 50, further comprising a sequence of instructions which, when executed by a processor, causes the processor to prepare read/write locking information for the remote computing element.

53. The computer-usable medium of claim 50, wherein the information identifying the remote computing element comprises a service identifier.

54. The computer-usable medium of claim 50, wherein the information identifying the remote computing element comprises a memory area identifier.

55. A computer-usable medium comprising a sequence of instructions which, when executed by a processor, causes the processor to:
deactivate a computing element;
de-allocate a memory area, the memory area to store incoming messages to the computing element;
delist the computing element; and
post information about the deactivated computing element to the network.

56. The computer-usable medium of claim 55, wherein the information about the computing element comprises a service identifier.

57. The computer-usable medium of claim 55, wherein the information about the computing element comprises a target memory area identifier.

58. The computer-usable medium of claim 55, further comprising a sequence of instructions which, when executed by a processor, causes the processor to deactivate read/write locking information for the computing element.

59. A computer-usable medium comprising a sequence of instructions which, when executed by a processor, causes the processor to:
receive information identifying a remote computing element;
de-list the remote computing element; and
de-allocate a memory area, the memory area to store outgoing messages to the remote computing element.

60. The computer-usable medium of claim 59, further comprising a sequence of instructions which, when executed by a processor, causes the processor to deactivate read/write locking information for the computing element.

61. The computer-usable medium of claim 59, wherein the information identifying the remote computing element comprises a service identifier.

62. The computer-usable medium of claim 59, wherein the information identifying the remote computing element comprises a source memory area identifier.
